(19) United States
(12) Patent Application Publication
(10) Pub. No.: US 2016/0345009 A1
(43) Pub. Date: Nov. 24, 2016

(54) ACCELERATING IMAGE ANALYSIS AND MACHINE LEARNING THROUGH IN-FLASH IMAGE PREPARATION AND PRE-PROCESSING

(71) Applicant: ScaleFlux, San Jose, CA (US)

(72) Inventors: Hao Zhong, Los Gatos, CA (US); Fei Sun, Irvine, CA (US); Yang Liu, Milpitas, CA (US)

(21) Appl. No.: 15/155,670

(22) Filed: May 16, 2016

Related U.S. Application Data
(60) Provisional application No. 62/163,905, filed on May 19, 2015.

(51) Int. Cl. H04N 19/132; H04N 19/44; H04N 19/162; G06K 9/66

(52) U.S. Cl. CPC H04N 19/132; G06K 9/66; H04N 19/44; H04N 19/162

(57) ABSTRACT

A system, method and device for processing video/image objects within a storage device. A device is disclosed that includes: a storage media; and a video/image processing engine for processing video/image objects based on a set of parameters provided by a host, wherein the video/image processing engine includes, for example: a decryption system for decrypting encrypted video/image objects; a bitstream decompression system; a content decompression system; and a resolution processing system that compares a resolution of raw image data with a requested resolution specified in the set of parameters.

### CROSS REFERENCE TO RELATED APPLICATION

This application claims priority to co-pending U.S. Provisional Patent Application Ser. No. 62/163,905 filed May 19, 2015, which is hereby incorporated herein as thoughtfully set forth.

### TECHNICAL FIELD

The present invention relates to the field of data storage and processing, and particularly to providing in-flash processing of video and image data to enhance image analysis and machine learning applications.

### BACKGROUND

A large variety of video and image centric tasks (e.g., deep learning, video and image analytics, and image retrieval) form an increasingly important category of workloads in data centers. Most image analysis tasks typically first apply various pixel-level processing functions to the interested image frames/regions, based upon which analysis and learning are carried out. In general, the pixel-level processing functions have well-defined and regular computation patterns and high computational complexity. In addition, since video/image data are stored in data storage devices in a compressed format (such as JPEG and MPEG), video/image decompression must be performed before any image processing functions can be applied. Video/image compression typically involves two steps: (1) First a compression is applied to the raw video/image content, which aims to exploit the characteristics of video/image content and human visual system to largely reduce the data size at small visual perception quality degradation. This is referred to as content compression. (2) Then an entropy lossless compression (e.g., arithmetic coding) is applied to further reduce the bitstream size, which is referred to bitstream compression. Accordingly, video/image decompression contains two steps, i.e., first bitstream decompression and then content decompression. Moreover, systems may also apply encryption to protect video/image data. Therefore, before servers to carry out any image analysis and machine learning tasks, they must obtain the raw image data by carrying out decryption, bitstream decompression, and content decompression.

Flash memory is being widely adopted in data centers to provide high-speed and low-cost solid-state data storage. Hence, for large-scale massive image analysis and learning in data centers, it is desirable for the computing servers to integrate high-speed flash-based storage devices for video/image data storage/buffering. In current practice, the host processors of servers are responsible for all the operations spanning over video/image decompression, image pre-processing, and image analysis and learning, which leads to severe stress on the computing and memory resources. In addition, due to the relative high bit cost of DRAM and large size of raw image data, image re-compression may be applied to decompressed raw image data to reduce the image footprint in DRAM, where image re-compression aims to modestly reduce the image size at much less compression/decompression computational complexity than compression schemes like JPEG. If image re-compression is used, host processors should also carry out re-compression as well. Moreover, although video/image resolution keeps increasing (e.g., from 720×480 to 1920×1080 and towards 7680×4320), many image analysis and learning tasks may not need very high solution. Hence, in order to reduce the stress on DRAM resources, host processors may further carry out image re-sampling after video/image decompression.

### SUMMARY

Typical image analysis and machine learning tasks involve a series of image data processing functions with different computational complexity/parallelism and data access patterns. It is not uncommon that some important and computation-heavy data processing functions have very regular data access pattern and computational parallelism, which make these functions naturally suitable for dedicated circuits with high computational parallelism, such as field programmable gate array devices.

Accordingly, embodiments of the present disclosure are directed implementing a flash-based data storage device that provides embedded image pre-processing functions, including decryption, decompression, image re-compression, image re-sampling, and other pixel-level image processing tasks.

A first aspect of the disclosure provides a data storage device, comprising: a storage media; and a video image processing engine for processing video/image objects being stored in the storage media based on a set of parameters provided by a host, wherein the video image processing engine includes: a decryption system for decrypting encrypted video/image objects; a bitstream decompression system; a content decompression system; and a resolution processing system that compares a resolution of raw image data with a requested resolution specified in the set of parameters.

A second aspect of the invention provides a method of processing video/image objects in a storage device, comprising: providing a video image processing engine within the storage device; receiving a set of parameters from a host that includes an identifier of a video/image object; reading the video/image object from a memory in the storage device; using the video image processing engine to decrypt the video/image object; and using the video image processing engine to perform a bitstream decompression and content decompression to generate a decrypted and decompressed video/image object.

A third aspect of the invention provides a computer program product stored on a computer readable storage medium, which when implemented by a video image processing engine in a storage device processes video/image objects being stored in a storage media based on a set of parameters provided by a host, wherein the computer program product includes: programming logic for decrypting encrypted video/image objects; programming logic for performing bitstream decompression; programming logic for performing content decompression; and programming logic that compares a resolution of raw image data with a requested resolution specified in the set of parameters.

Further aspects include providing region of interest processing, applying a pre-processing functions and providing recompression.

### BRIEF DESCRIPTION OF THE DRAWINGS

The numerous embodiments of the present invention may be better understood by those skilled in the art by reference to the accompanying figures in which:

FIG. 1 illustrates the overall structure of the device according to embodiments;

FIG. 2 illustrates the flow diagram when the storage device controller only needs to support certain image data preparation functions according to embodiments;

FIG. 3 illustrates the flow diagram of the host processor further requests the storage device controller to carry out certain pre-processing functions according to embodiments;

FIG. 4 depicts a video image processing engine according to embodiments.

### DETAILED DESCRIPTION

Reference will now be made in detail to the embodiments of the invention, examples of which are illustrated in the accompanying drawings.

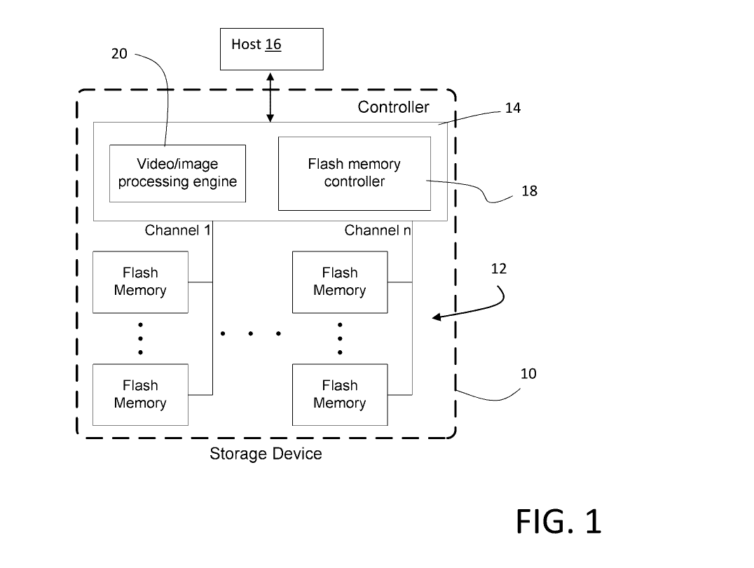

As shown in FIG. 1, a flash-based storage device 10 contains flash memory 12 and a controller 14, both of which may for example be implemented with one or more integrated circuit chips. Flash memory 12 generally comprises flash memory chips arranged for example in channels for storing data, including video and image data. Controller 14 generally includes a flash memory controller 18 that supports data access for flash memory 12 and a video/image processing engine 20 that carries out specialized “in-flash” video/image processing operations.

For the purposes of these embodiments, videos and images are stored in the flash-based data storage device 10 as video/image objects with unique object identifiers. Generally, every video/image object being stored in the flash-based data storage device 10 is compressed (e.g., using JPEG or MPEG) in order to reduce the footprint in flash memory 12. Typical video compression (e.g., H.264 or the latest HEVC) can reduce the data size by at least 50˜100×, and image compression (e.g., JPEG) can reduce the data size by at least 5˜10×.

The video/image processing engine 20 is configured to carry out various specialized functions that will reduce processing typically done on the host 16 (e.g., by a central processing unit, server, etc.). One such category of functions implemented by video/image processing engine 20 includes image data preparation functions. These functions are responsible for converting the highly compressed (and possibly encrypted) video/image objects in the storage device 10 into formats suitable for further image processing by the host 16. Typical image data preparation functions include, e.g., decryption, bitstream decompression, content decompression, image re-sampling, and image re-compression.

A second category of functions provided by video/image processing engine 20 includes image data pre-processing functions. These functions are responsible for carrying out routine image processing functions within the overall image analysis tasks. These functions have high computational complexity and parallelism with relative regular data access patterns, which make them suitable to be off-loaded from the host 16 to dedicated circuits inside the data storage device 10. Example pre-processing functions include image filtering, convolution, gray scaling, etc.

To utilize the image preparation and pre-processing capability of the storage device controller 14, the host 16 provides a set of parameters to the storage device, including: (1) the object identifiers of the video or images to be processed, (2) desired object data resolution, (3) the region of interest within each image frame, which will be processed, and (4) function information regarding the particular pre-processing function to be executed by the controller 14 and necessary configuration parameters.

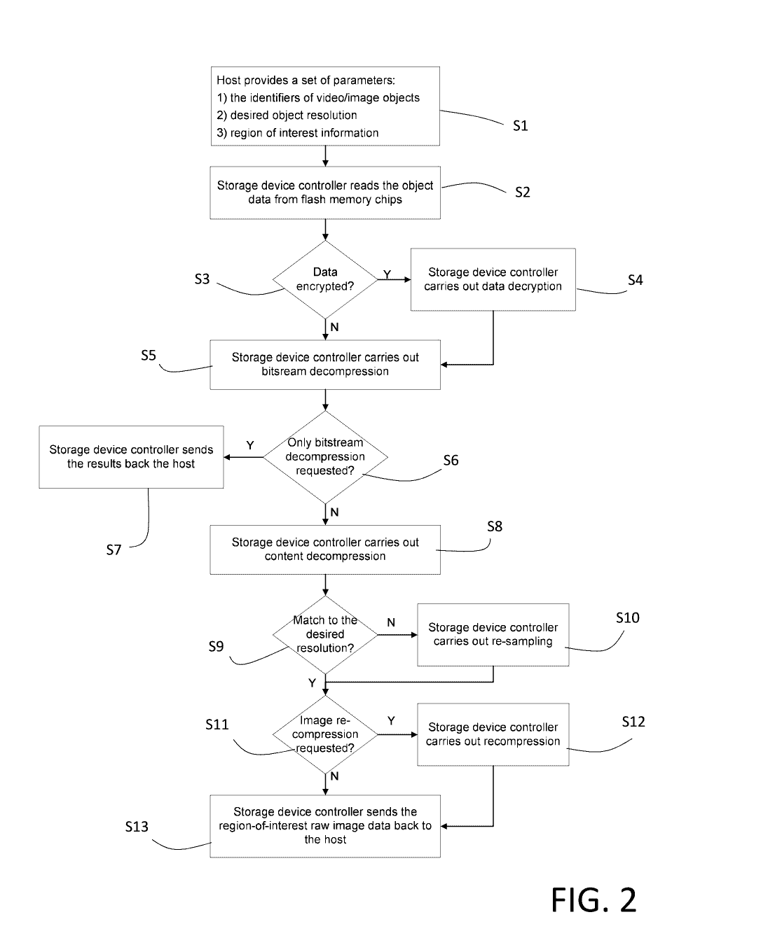

FIG. 2 shows a flow diagram of an illustrative process of implementing “in-flash” data preparation functions on video/image objects stored in a storage device 10. At S1, the storage device 10 receives parameters from host 16 including: an identifier of one or more video/image objects, desired object resolution(s), and region(s) of interest information. Upon receiving the parameters, the controller 14 fetches (i.e., reads) the highly compressed video/image objects from the flash memory 12 at S2 and at S3 a determination is made whether the data in encrypted. If the compressed video/image objects are encrypted, the controller 14 first carries out decryption to obtain the original compressed video/image bitstream at S4.

At S5, the controller 14 carries out bitstream decompression and, if requested by the host S6, carries out the content decompression at S8. If only bitstream decompression is requested at S6, the controller 14 sends the results back to the host 16 at S7. Otherwise, at S9, controller 14 checks to see if the resulting decompressed image (in raw pixelated form) matches the desired resolution requested by the host 16. If the desired resolution does not match to the native resolution of the video/image object, the storage device controller 14 carries out the image re-sampling at S10 to create an image at the desired resolution. As part of this step, the video/image object can be cropped or otherwise reduced to a specified region of interest if requested, e.g., based on coordinates, pixel values, frequency data, etc. The controller 14 may also check to see if image recompression is requested for the raw (pixelated) image data by the host 16 at S11, and if so carries out the image recompression at S12, e.g., to create a JPEG image. Finally, the controller sends the resulting processed video/image object, e.g., a compressed region-of-interest image, back to the host 16 at S13.

Note that if the host 16 relies on the storage device controller 14 to carry out both bitstream and content decompression (i.e., the entire video/image decompression), the host 14 need not be concerned with the compressed video/image format in which the video/image data is stored in the memory, which can simplify the host implementation. Namely, the host software stack can be implemented to input and output only uncompressed raw image frames with the storage device 10, and allow the storage device 10 to internally handle any compression/decompression tasks.

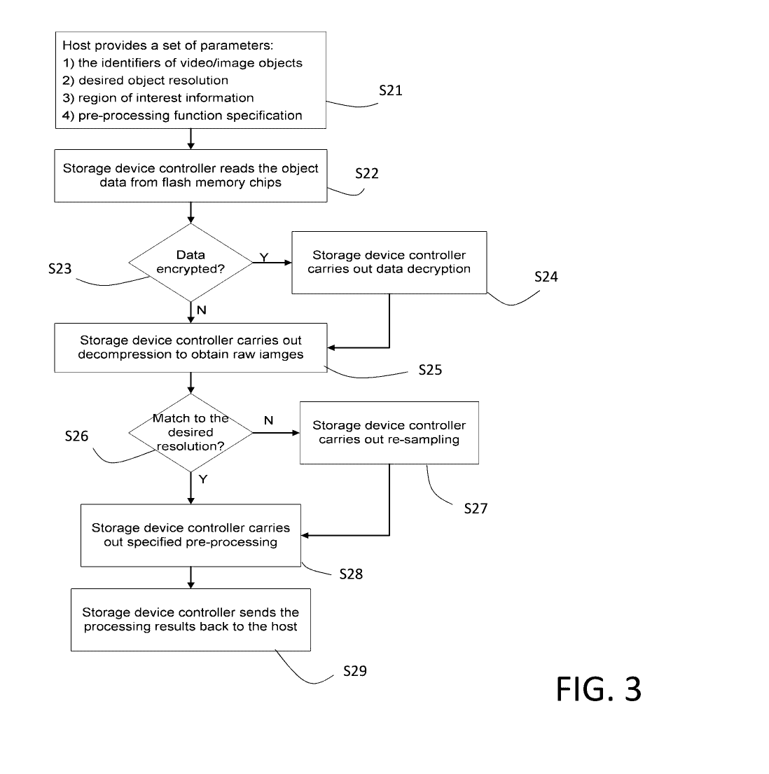

FIG. 3 shows a flow diagram of an illustrative process of implementing “in-flash” pre-processing functions (e.g., convolution). In this context, the host 16 provides to the controller 14 parameters at S21 including: an identifier or one or more video/image objects, desired object resolution(s), region of interest information, and specification of the pre-processing functions to be executed by the controller 14. Upon receiving the parameters, the controller 14 fetches (i.e., reads) a compressed video/image object from the flash memory 12 at S22 and at S23 a determination is made whether the video/image object is encrypted. If the compressed video/image object is encrypted, the controller 14 first carries out decryption at S24.

Next, at S25, controller 14 carries out decompression to obtain the raw image data and a check is made at S26 to see if the desired resolution is matched. If the raw image resolution is different than the desired resolution, re-sampling is further carried out at S27, and at S28 the storage device controller 14 carries out the specified pre-processing function(s) on the raw image data, and sends the results to the host 16 at S29. Similar to the embodiment of FIG. 2, the raw image data may be reduced to a region of interest and compressed before being sent back to the host 16.

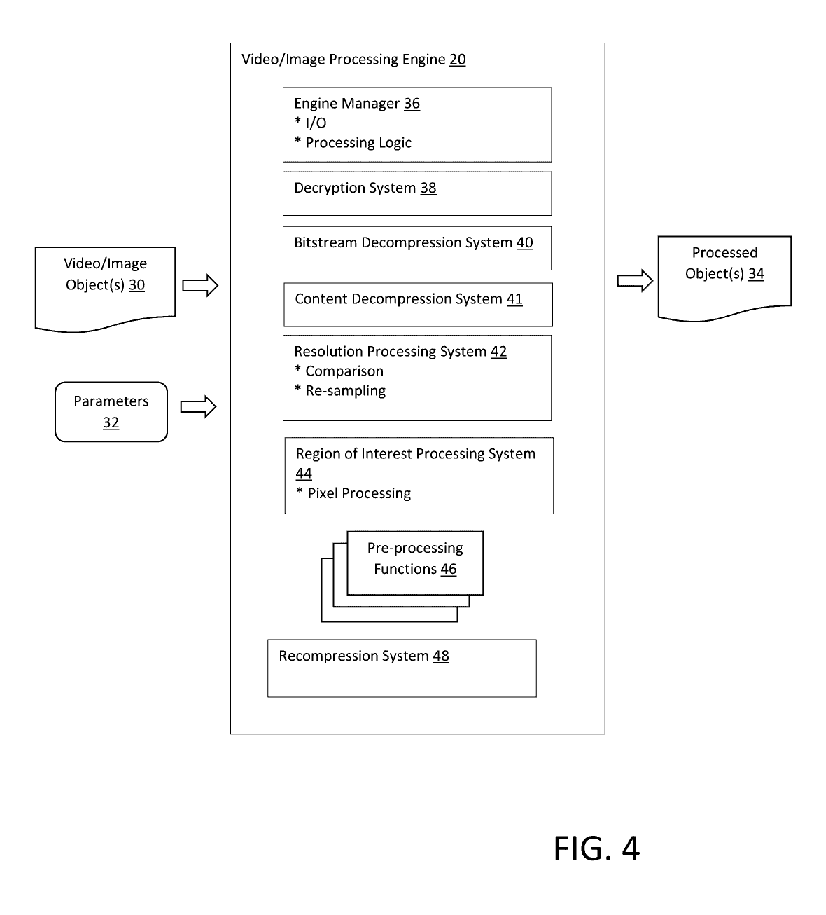

FIG. 4 depicts an illustrative embodiment of video/image processing engine 20, which generally processes a video/image object 30 specified by the controller 14 and generates a processed object 34. Note that in the described embodiments, the video/image object 30 is read from flash memory 12 for use by the host 16. However, it is understood that video/image processing engine 20 may likewise be used to process video/image objects 30 from the host 16 being stored in flash memory 12. Also inputted are a set of parameters 32 from the host 16, which controls the implementation of video/image processing engine 20 for processing the video/image object 30.

In this example, video/image processing engine 20 includes an engine manager 36 that handles the input and output of objects 30 and parameters 32, and manages the processing logic (e.g., the flow diagrams shown in FIGS. 2 and 3. In this illustrative embodiment, video/image processing engine 20 includes the following systems that can be utilized as specified by the host 16 and processing logic. As noted, by implementing lower level repetitive tasks at the storage device 10, the computational bandwidth of the host 16 is freed up to perform the more higher level complex image processing tasks, such as image analysis and machine learning. Accordingly, the video/image processing engine 20 may be implemented with more or less functionality than shown without departing from the scope of the invention.

Decryption system 38 is provided to decrypt video/image object 30 if encrypted. The particular decryption algorithm is implemented based on the type of encryption used when the video/image object 30 was stored (e.g., Guassian elimination, discrete cosine transform, etc.). Bitstream decompression system 38 is provided to undo any bitstream compression (e.g., arithmetic coding/decoding) and content decompression system 41 is utilized to undo any content decompression (e.g., JPEG, MPEG, etc.). Resolution processing system 42 performs functions related to resolution including comparing a decompressed image to a target resolution, and re-sampling if necessary. Resolution comparisons may be done, e.g., by comparing pixel dimensions. Any re-sampling algorithm may be utilized to rescale pixel data (e.g., nearest neighbor, bilinear, etc.). Region of interest processing system 44 provides a process for selecting/cropping a section of the raw image data.

Preprocessing functions 46 may, e.g., comprise a library of functions, which may specified as needed by the host 16. Examples include e.g., convolution, filtering, conversion to grayscale, etc. Finally, recompression system 48 is provided to recompress raw image data when requested by the host 16.

The embodiments of the present disclosure are applicable to various types of storage devices without departing from the spirit and scope of the present disclosure. It is also contemplated that the term host may refer to various devices capable of sending read/write commands to the storage devices. It is understood that such devices may be referred to as processors, hosts, initiators, requesters or the like, without departing from the spirit and scope of the present disclosure.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by processing logic implemented in hardware and/or computer readable program instructions. For example, video image processing engine 20 may be implemented with field programmable gate array (FPGA) devices, application specific integrated circuit (ASIC) devices, general purpose IC's and/or any other device.

Computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A data storage device, comprising:
a storage media; and
a video/image processing engine for processing video/image objects being stored in the storage media based on a set of parameters provided by a host, wherein the video/image processing engine includes:
a decryption system for decrypting encrypted video/image objects;
a bitstream decompression system;
a content decompression system; and
a resolution processing system that compares a resolution of raw image data with a requested resolution specified in the set of parameters.

2. The data storage device of claim 1, wherein the storage media includes flash memory.

3. The data storage device of claim 1, wherein the resolution processing system further provides re-sampling of the raw image data to the requested resolution.

4. The data storage device of claim 1, wherein the video/image processing engine further comprises a region of interest processing system that crops raw image data according to requirements specified in the set of parameters.

5. The data storage device of claim 1, wherein the video/image processing engine further comprises a recompression system that recompresses raw image data.

6. The data storage device of claim 1, wherein the video/image processing engine further comprises a set pre-processing functions that can be applied to the raw image data according to requirements specified in the set of parameters.

7. The data storage device of claim 1, wherein the video/image processing engine further comprises an engine manager for handling input and output of video/image objects and processing logic.

8. A computer program product stored on a computer readable storage medium, which when implemented by a video/image processing engine in a storage device processes video/image objects being stored in a storage media based on a set of parameters provided by a host, wherein the computer program product includes:
programming logic for decrypting encrypted video/image objects;
programming logic for performing bitstream decompression;
programming logic for performing content decompression; and
programming logic that compares a resolution of raw image data with a requested resolution specified in the set of parameters.

9. The computer program product of claim 8, wherein the storage media includes flash memory.

10. The computer program product of claim 8, further comprising programming logic that provides re-sampling of the raw image data to the requested resolution.

11. The computer program product of claim 8, further comprising programming logic that crops raw image data according to requirements specified in the set of parameters.

12. The computer program product of claim 8, further comprising programming logic that recompresses raw image data.

13. The computer program product of claim 8, further comprising programming logic that provides a set pre-processing functions that can be applied to the raw image data according to requirements specified in the set of parameters.

14. The computer program product of claim 8, further comprising programming logic that handles input and output of video/image objects and processing logic.

15. A method of processing video/image objects in a storage device, comprising:
providing a video/image processing engine within the storage device;
receiving a set of parameters from a host that includes an identifier of a video/image object;
reading the video/image object from a memory in the storage device;
using the video/image processing engine to decrypt the video/image object; and
using the video/image processing engine to perform a bitstream decompression and a content decompression to generate a decrypted and decompressed video/image object.

16. The method of claim 15, further comprising using the video/image processing engine to:
compare a resolution of the decrypted and decompressed video/image object with a requested resolution specified in the set of parameters; and
re-scale the resolution to meet the requested resolution specified in the set of parameters if the resolution differs from the requested resolution.

17. The method of claim 15, further comprising using the video/image processing engine to apply a pre-processing function to the decrypted and decompressed video/image object.

18. The method of claim 17, wherein the pre-processing function is selected from a group consisting of: convolution and filtering.

19. The method of claim 15, further comprising using the video/image processing engine to crop the decrypted and decompressed video/image object to a region of interest specified by the set of parameters.

20. The method of claim 15, further comprising using the video/image processing engine to recompress the decrypted and decompressed video/image object.
